(19) United States
(12) Patent Application Publication
(10) Pub. No.: US 2007/0122741 A1
(43) Pub. Date: May 31, 2007

(54) Resist protective coating material and patterning process

(75) Inventors: Jun Hatakeyama, Joetsu-shi (JP); Katsuya Takemura, Joetsu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SHIN-ETSU CHEMICAL CO., LTD., Tokyo (JP)

(21) Appl. No.: 11/604,695

(22) Filed: Nov. 28, 2006

(30) Foreign Application Priority Data
Nov. 29, 2005 (JP) 2005-343101
Apr. 25, 2006 (JP) 2006-120106

(51) Int. Cl. G03C 1/00

(52) U.S. Cl. 430/270.1

(57) ABSTRACT

A pattern-forming process uses a resist protective coating material comprising a C₈-C₁₂ ether compound as a solvent. A resist protective coating formed on a resist film is water-insoluble, soluble in an alkaline developer, and unmixable with the resist film, and thus the immersion lithography can be performed. During alkaline development, development of the resist film and removal of the protective coating can be achieved in a single step at the same time.

### CROSS-REFERENCE TO RELATED APPLICATION

This non-provisional application claims priority under 35 U.S.C. §119(a) on Patent Application Nos. 2005-343101 and 2006-120106 filed in Japan on Nov. 29, 2005 and Apr. 25, 2006, respectively, the entire contents of which are hereby incorporated by reference.

### TECHNICAL FIELD

This invention generally relates to a micropatterning process for the fabrication of semiconductor devices, and particularly to an immersion photolithography process involving directing ArF excimer laser radiation having a wavelength of 193 nm from a projection lens toward a wafer, with water intervening between the lens and the wafer. More particularly, it relates to a resist protective coating material used as a resist overlay for protecting a photoresist film and a process for forming a resist pattern using the same.

### BACKGROUND ART

In the recent drive for higher integration and operating speeds in LSI devices, the pattern rule is made drastically finer. The photolithography which is currently on widespread use in the art is approaching the essential limit of resolution determined by the wavelength of a light source. As the light source used in the lithography for resist pattern formation, g-line (436 nm) or i-line (365 nm) from a mercury lamp was widely used. One means believed effective for further reducing the feature size is to reduce the wavelength of exposure light. For the mass production process of 64 M-bit dynamic random access memory (DRAM, processing feature size 0.25 μm or less), the exposure light source of i-line (365 nm) was replaced by a KrF excimer laser having a shorter wavelength of 248 nm. However, for the fabrication of DRAM with a degree of integration of 256 M and 1 G or more requiring a finer patterning technology (processing feature size 0.2 μm or less), a shorter wavelength light source is required. Over a decade, photolithography using ArF excimer laser light (193 nm) has been under active investigation. It was expected at the initial that the ArF lithography would be applied to the fabrication of 180-nm node devices. However, the KrF excimer lithography survived to the mass-scale fabrication of 130-nm node devices. So, the full application of ArF lithography started from the 90-nm node. The ArF lithography combined with a lens having an increased numerical aperture (NA) of 0.9 is considered to comply with 65-nm node devices. For the next 45-nm node devices which required an advancement to reduce the wavelength of exposure light, the F₂ lithography of 157 nm wavelength became a candidate. However, for the reasons that the projection lens uses a large amount of expensive CaF₂ single crystal, the scanner thus becomes expensive, hard pellicles are introduced due to the extremely low durability of soft pellicles, the optical system must be accordingly altered, and the etch resistance of resist is low; the postponement of F₂ lithography and the early introduction of ArF immersion lithography were advocated (see Proc. SPIE Vol. 4690 xxix).

In the ArF immersion lithography, the space between the projection lens and the wafer is filled with water. Since water has a refractive index of 1.44 at 193 nm, pattern formation is possible even using a lens with NA of 1.0 or greater. Theoretically, it is possible to increase the NA to 1.44. The resolution is improved by an increment of NA. A combination of a lens having NA of at least 1.2 with ultra-high resolution technology suggests a way to the 45-nm node (see Proc. SPIE Vol. 5040, p724).

Several problems associated with the presence of water on resist were pointed out. For example, profile changes occur because the acid once generated from a photoacid generator and the amine compound added to the resist as a quencher can be dissolved in water. The pattern collapses due to swelling. It was then proposed to provide a protective coating between the resist and water (see the 2nd Immersion Workshop, Jul. 11, 2003, Resist and Cover Material Investigation for Immersion Lithography).

In the lithography history, the protective coating on the resist layer was studied as an antireflective coating. For example, the antireflective coating on resist (ARCOR) process is disclosed in JP-A 62-62520, JP-A 62-62521, and JP-A 60-38821. The ARCOR process involves forming a transparent antireflective coating on top of a resist film and stripping it after exposure. Despite its simplicity, the process can form a micropattern at a high degree of definition, precision and alignment. When the antireflective coating is made of perfluoroalkyl compounds (e.g., perfluoroalkyl polyethers or perfluoroalkyl amines) having a low refractive index, the light reflection at the resist/antireflective coating interface is minimized so that the dimensional precision is improved. In addition to these materials, the fluorinated materials proposed thus far include amorphous polymers such as perfluoro(2,2-dimethyl-1,3-dioxol)-tetrafluoroethylene copolymers and cyclic polymers of perfluoro(allyl vinyl ether) and perfluorobutenyl vinyl ether as disclosed in JP-A 5-74700.

Because of their low compatibility with organic substances, the foregoing perfluoroalkyl compounds must be diluted with fluorocarbon solvents such as Freon for controlling a coating thickness. As is well known in the art, the use of fluorocarbons now raises an issue from the standpoint of environmental protection. The perfluoroalkyl compounds are awkward to form uniform films, and are not regarded satisfactory as antireflective films. Additionally, the antireflective films must be stripped with fluorocarbon solvents prior to the development of photoresist. These factors lead to serious practical disadvantages including a need to add an antireflective film-stripping unit to the existing system and the increased cost of fluorocarbon solvents.

If the antireflective film is to be stripped without adding an extra unit to the existing system, it is most desirable to carry out stripping in the development unit. The solutions used in the photoresist development unit are an alkaline aqueous solution as the developer and deionized water as the rinse. It would be desirable to have an antireflective coating material which can be readily stripped with such solutions. For this reason, there were proposed a number of water-soluble antireflective coating materials and patterning processes using the same. See, for example, JP-A 6-273926 and Japanese Patent No. 2,803,549.

The water-soluble protective coatings, however, cannot be used in the immersion lithography because they are dissolved away in water during light exposure. On the other hand, water-insoluble fluoro-polymers pose a need for special fluorocarbon strippers and an exclusive stripping cup for fluorocarbon solvents. It was thus desired to have a resist protective coating which is water insoluble, but can be readily stripped.

Studies have been made to use methacrylate polymers having hexafluoroalcohol groups as a resist protective coating for the immersion lithography because of their alkali solubility and high water repellency (see Journal of Photopolymer Science and Technology, Vol. 18, No. 5 (2005) p 615-619).

There exists a demand for a resist protective coating which is more hydrophobic and alkali developable.

In connection with the spin coating technique of photoresist solution, it would be desirable to reduce the amount of the solution dispensed. If a photoresist solution is dispensed and spin coated onto a substrate which has been wetted with a photoresist solvent or a solution miscible with the photoresist solvent, then the spreading of the photoresist solution over the substrate is facilitated. Such a method of reducing the amount of a photoresist solution dispensed is proposed in JP-A 9-246173. This is also true to the formation of a resist protective coating by spin coating.

### SUMMARY OF THE INVENTION

An object of the invention is to provide a resist protective coating material which is best suited for the immersion lithography in that it enables-effective pattern formation by the immersion lithography, it can be removed at the same time as the development of a photoresist layer, and it has improved process compatibility; and a pattern forming process using the same.

The inventors have discovered that when a resist protective coating solution is applied onto a resist film to form a resist protective coating thereon, the use of an ether compound of 8 to 12 carbon atoms as the solvent of the solution helps form the protective coating without dissolving the resist film and without adversely affecting the pattern profile and process margin.

In connection with the immersion lithography, the inventors proposed in Japanese Patent Application No. 2005-305183 to use a higher alcohol of 4 or more carbon atoms as a solvent for the resist protective coating material.

In the case of photoresist materials based on (meth)acrylic polymers, it is possible to use higher alcohols of 4 or more carbon atoms capable of dissolving resist protective coating polymers having alpha-fluoroalcohol groups, but not (meth)acrylic polymers substantially. However, cycloolefin polymers derived from polynorbornene and ring-opening metathesis polymers (ROMP), and silsesquioxane polymers are dissolvable in alcohols of 4 or more carbon atoms. If resist protective coatings using alcohol as the solvent are applied onto resists based on cycloolefin polymers derived from polynorbornene and ROMP and silsesquioxane polymers, there arises a problem that the resist patterns following development are configured to bulged tops or slimmed.

In contrast, ether compounds of 8 to 12 carbon atoms are solvents which do not dissolve cycloolefin polymers and silsesquioxane polymers, but protective coating polymers having alpha-trifluoromethyl alcohol groups.

Accordingly, the present invention provides a resist protective coating material and a pattern-forming process, as defined below.

In one aspect, the invention provides a resist protective coating material comprising an ether compound of 8 to 12 carbon atoms as a solvent.

The ether compound is typically selected from among di-n-butyl ether, diisobutyl ether, di-sec-butyl ether, di-n-pentyl ether, diisopentyl ether, di-sec-pentyl ether, di-t-amyl ether, and di-n-hexyl ether, and mixtures thereof. Most preferably, the ether-compound is diisopentyl ether.

The resist protective coating material may further comprise 0.1 to 90% by weight of a higher alcohol of 4 to 10 carbon atoms in admixture with the ether compound. It may further comprise a fluorochemical solvent.

Typically the resist protective coating material may further comprise an alkali-soluble polymer having alpha-trifluoromethyl alcohol groups. The alkali-soluble polymer comprises recurring units having an alpha-trifluoromethyl alcohol group, and recurring units having a fluoroalkyl group and/or recurring units having an alkyl group. Optionally, the polymer further comprises recurring units having a carboxyl group.

In another aspect, the invention provides a lithography process for forming a pattern, comprising the steps of forming a photoresist layer on a wafer, forming a protective coating on the photoresist layer from a resist overlay material, exposing the layer structure to light, and developing; and an immersion lithography process for forming a pattern, comprising the steps of forming a photoresist layer on a wafer, forming a protective coating on the photoresist layer from a resist overlay material, exposing the layer structure in water to light, and developing; wherein the resist overlay material is the resist protective coating material defined above.

In the preferred immersion lithography process, the exposing step includes irradiating light having a wavelength in the range of 180 to 250 nm to the layer structure through a projection lens while keeping water between the projection lens and the wafer. Preferably the developing step is to develop the photoresist layer and strip the protective coating of resist overlay material at the same time, using a liquid alkaline developer.

The invention also provides an immersion lithography process for forming a pattern, comprising the steps of forming a photoresist layer on a wafer, wetting the photoresist layer with a solution containing an ether compound of 8 to 12 carbon atoms, forming a protective coating on the photoresist layer from a resist overlay material by spin coating, exposing the layer structure in water to light, and developing, wherein the resist overlay material is the resist protective coating material defined above.

### BENEFITS OF THE INVENTION

A pattern-forming process using the resist protective coating material of the invention has many advantages. Since a resist protective coating formed on a resist film is insoluble in water, soluble in an aqueous alkaline solution (alkaline developer), and unmixable with the resist film, the immersion lithography can be performed in a satisfactory manner. During alkaline development, development of the resist film and removal of the protective coating can be achieved in a single step at the same time.

### DESCRIPTION OF THE PREFERRED EMBODIMENTS

The invention addresses the immersion lithography process for forming a pattern by forming a photoresist layer on a wafer, forming a protective coating on the photoresist layer from a resist overlay material, exposing the layer structure in water to light, and developing. The resist protective coating material of the invention is best suited as the resist overlay material and characterized by comprising an ether compound of 8 to 12 carbon atoms.

Suitable ether compounds of 8 to 12 carbon atoms include di-n-butyl ether, diisobutyl ether, di-sec-butyl ether, di-n-pentyl ether, diisopentyl ether, di-sec-pentyl 1o ether, di-t-amyl ether, and di-n-hexyl ether, which may be used alone or in admixture.

Those solvents which do not dissolve cycloolefin polymers and polysilsesquioxanes include alkanes such as octane, nonane and decane, and aromatic solvents such as toluene, xylene and anisole. However, since protective coating polymers having alpha-trifluoromethyl alcohol groups are also substantially insoluble in these solvents, these solvents cannot be used as the main solvent for resist protective coating material.

The solvents which do not dissolve cycloolefin polymers and polysilsesquioxanes, but dissolve protective coating polymers having alpha-trifluoromethyl alcohol groups include ether compounds.

Ether compounds of 7 or less carbon atoms have a low flash point, possessing a risk of explosion. Ether compounds of 13 or more carbon atoms have a boiling point equal to or higher than 250° C. and do not volatilize off during the prebaking step in the range of 100 to 130° C. For a balance of flash point and boiling point, C₈-C₁₂ ether compounds are appropriate.

In admixture with the ether compound, a higher alcohol of 4 to 10 carbon atoms is preferably present in an amount of 0.1 to 90% by weight, more preferably 0.15 to 80% by weight, and even more preferably 0.2 to 70% by weight based on the ether compound and the alcohol combined.

The ether compounds are liquids with a low viscosity and a low surface tension. The low viscosity and surface tension offer an advantage of gaining a flow rate during filtration due to a low filtration pressure, but make it difficult to maintain a liquid surface at the nozzle tip of a coater cup, allowing for free dropping of liquid droplets from the nozzle tip. As the liquid quantity at the nozzle tip is reduced, the nozzle tip is dried up, allowing the polymer to precipitate and eventually causing coating defects. Admixing of a C₄-C₁₀higher alcohol can overcome this drawback.

Examples of the C₄-C₁₀ higher alcohol include, but are not limited to, 1-butyl alcohol, 2-butyl alcohol, isobutyl alcohol, tert-butyl alcohol, 1-pentanol, 2-pentanol, 3-pentanol, tert-amyl alcohol, neopentyl alcohol, 2-methyl-1-butanol, 3-methyl-1-butanol, 3-methyl-3-pentanol, cyclopentanol, 1-hexanol, 2-hexanol, 3-hexanol, 2,3-dimethyl-2-butanol, 3,3-dimethyl-1-butanol, 3,3-dimethyl-2-butanol, 2-ethyl-1-butanol, 2-methyl-1-pentanol, 2-methyl-2-pentanol, 2-methyl-3-pentanol, 3-methyl-1-pentanol, 3-methyl-2-pentanol, 3-methyl-3-pentanol, 4-methyl-1-pentanol, 4-methyl-2-pentanol, 4-methyl-3-pentanol, cyclohexanol, and 1-octanol. They may be used alone or in admixture of two or more.

In another preferred embodiment, a fluorochemical solvent is used in admixture with the C₈-C₁₂ ether compound because the fluorochemical solvent does not dissolve the resist layer.

Examples of suitable fluorochemical solvents include, but are not limited to, 2-fluoroanisole, 3-fluoroanisole, 4-fluoroanisole, 2,3-difluoroanisole, 2,4-difluoroanisole, 2,5-difluoroanisole, 5,8-difluoro-1,4-benzodioxane, 2,3-difluorobenzyl alcohol, 1,3-difluoro-2-propanol, 2′, 4′-difluoropropiophenone, 2,4-difluorotoluene, trifluoroacetaldehyde ethyl hemiacetal, trifluoroacetamide, trifluoroethanol, 2,2,2-trifluoroethyl butyrate, ethyl heptafluorobutyrate, ethyl heptafluorobutylacetate, ethyl hexafluoroglutarylmethyl, ethyl 3-hydroxy-4,4,4-trifluorobutyrate, ethyl 2-methyl-4,4,4-trifluoroacetoacetate, ethyl pentafluorobenzoate, ethyl pentafluoropropionate, ethyl pentafluoropropinylacetate, ethyl perfluorooctanoate, ethyl 4,4,4-trifluoroacetoacetate, ethyl 4,4,4-trifluorobutyrate, ethyl 4,4,4-trifluorochrotonate, ethyl trifluorosulfonate, ethyl 3-(trifluoromethyl)butyrate, ethyl trifluoropilvate, S-ethyl trifluoroacetate, fluorocyclohexane, 2,2,3,3,4,4,4-heptafluoro-1-butanol, 1,1,1,2,2,3,3-heptafluoro-7,7-dimethyl-4,6-octanedione, 1,1,1,3,5,5,5-heptafluoropentane-2,4-dione, 3,3,4,4,5,5,5-heptafluorzo-2-pentanol, 3,3,4,4,5,5,5-heptafluoro-2-pentanone, isopropyl 4,4,4-trifluoroacetoacetate, methyl perfluorodecanoate, methyl perfluoro(2-methyl-3-oxahexanoate), methyl perfluorononanoate, methyl perfluorooctanoate, methyl 2,3,3,3-tetrafluoropropionate, methyl trifluoroacetoacetate, 1,1,1,2,2,6,6,6-octafluoro-2,4-hexanedione, 2,2,3,3,4,4,5,5-octafluoro-1-pentanol, 1H,1H,2H,2H-perfluoro-1-decanol, perfluoro(2,5-dimethyl-3,6-dioxane anionic)acid methyl ester, 2H-perfluoro-5-methyl-3,6-dioxanonane, 1H,1H,2H,3H,3H-perfluorononane-1,2-diol, 1H,1H,9H-perfluoro-1-nonanol, 1H,1H-perfluorooctanol, 1H,1H,2H,2H-perfluorooctanol, 2H-perfluoro-5,8,11,14-tetramethyl-3,6,9,12,15-pentaoxa-octadecane, perfluorotributylamine, perfluorotrihexylamine, perfluoro-2,5,8-trimethyl-3,6,9-trioxadodecanoic acid methyl ester, perfluorotripentylamine, perfluorotripropylamine, 1H,1H,2H,3H,3H-perfluoroundecane-1,2-diol, trifluorobutanol, 1,1,1-trifluoro-5-methyl-2,4-hexanedione, 1,1,1-trifluoro-2-propanol, 3,3,3-trifluoro-1-propanol, 1,1,1-trifluoro-2-propylacetate, perfluorobutyltetrahydrofuran, perfluoro(butyltetrahydrofuran), perfluorodecalin, perfluoro(1,2-dimethylcyclohexane), perfluoro(1,3-dimethylcyclohexane), propylene glycol trifluoromethyl ether acetate, propylene glycol methyl ether trifluoromethyl acetate, butyl trifluoromethylacetate, methyl 3-trifluoromethoxypropionate, perfluorocyclohexanone, propylene glycol trifluoromethyl ether, butyl trifluoroacetate, 1,1,1-trifluoro-5,5-dimethyl-2,4-hexanedione, 1,1,1,3,3,3-hexafluoro-2-propanol, 1,1,1,3,3,3-hexafluoro-2-methyl-2-propanol, 2,2,3,4,4,4-hexafluoro-1-butanol, 2-trifluoromethyl-2-propanol, 2,2,3,3-tetrafluoro-1-propanol, 3,3,3-trifluoro-1-propanol, and 4,4,4-trifluoro-1-butanol. They may be used alone or in admixture of two or more. The fluorochemical solvent is admixed in an amount of 0 to 90% by weight based on the ether compound and the alcohol combined.

In the C₈-C₁₂ ether compound, the photoresist film is not substantially dissolved. Therefor, when the photoresist film is previously wetted with a solution of the C₈-C₁₂ ether compound and a resist protective coating material is then dispensed and spin coated on the photoresist film, an improvement in coating uniformity of the resist protective coating material can be achieved, thus reducing the amount of the resist protective coating material dispensed. The photoresist film is wetted with a solution of the C₈-C₁₂ ether compound by several techniques, which include a technique of dispensing a solution of the C₈-C₁₂ ether compound onto the photoresist film while rotating the wafer; and a technique of spraying a solution of the C₈-C₁₂ ether compound in vapor form to the photoresist film. In the wetting solution, the concentration of the C₈-C₁₂ ether compound is preferably in the range of 5 to 100% by weight, more preferably 10 to 100% by weight. Examples of the solvent to be mixed with the C₈-C₁₂ ether compound include alcohol solvents and fluorochemical solvents as described above, and alkanes, and mixtures of two or more thereof.

In a preferred embodiment, the resist protective coating material further comprises an alkali-soluble polymer having alpha-trifluoromethyl alcohol groups. As used herein, the term “alkali-soluble polymer” refers to a polymer which is dissolvable at room temperature in an aqueous alkaline solution having a concentration of 0.1 to 0.3N alkali, preferably 0.26N alkali, i.e., 2.38 wt % tetramethylammonium hydroxide (TMAH) aqueous solution.

In general, the alpha-trifluoromethyl alcohol groups have the formula (1). 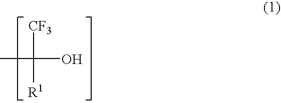
Herein, R¹ is a monovalent group such as a hydrogen atom or a straight, branched or cyclic C₁-C₁₀ alkyl or fluorinated alkyl group. Alternatively, R¹ is a divalent group having a valence bond, for example a straight, branched or cyclic C₁-C₁₀ alkylene or fluorinated alkylene group, which may contain an ether bond (—O—).

The preferred alkali-soluble polymers having alpha-trifluoromethyl alcohol groups of formula (1) are those comprising any of recurring units “a” having alpha-trifluoromethyl alcohol groups of formula (1) as shown below.

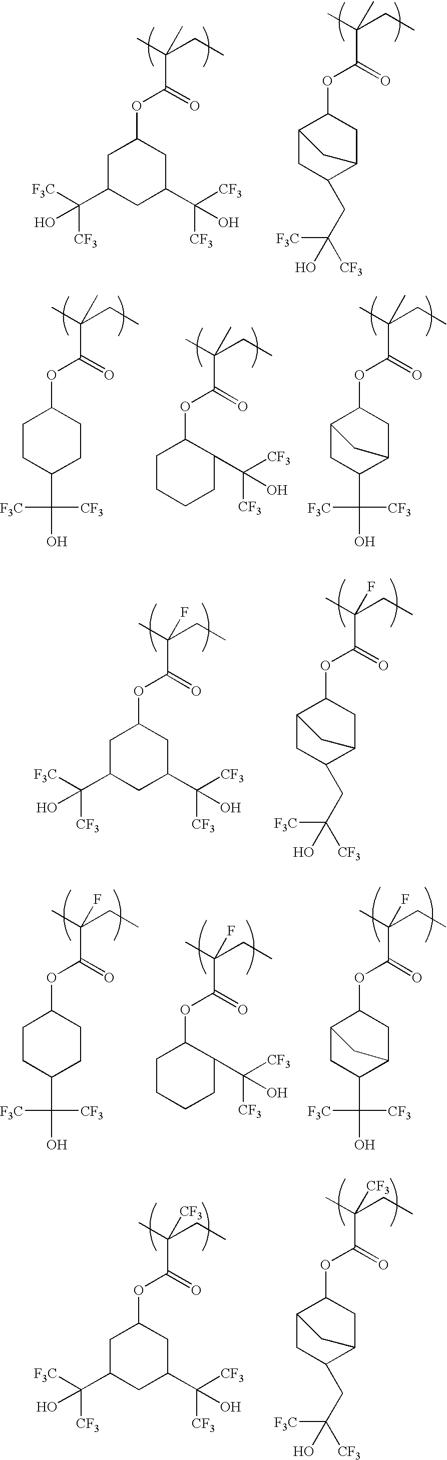

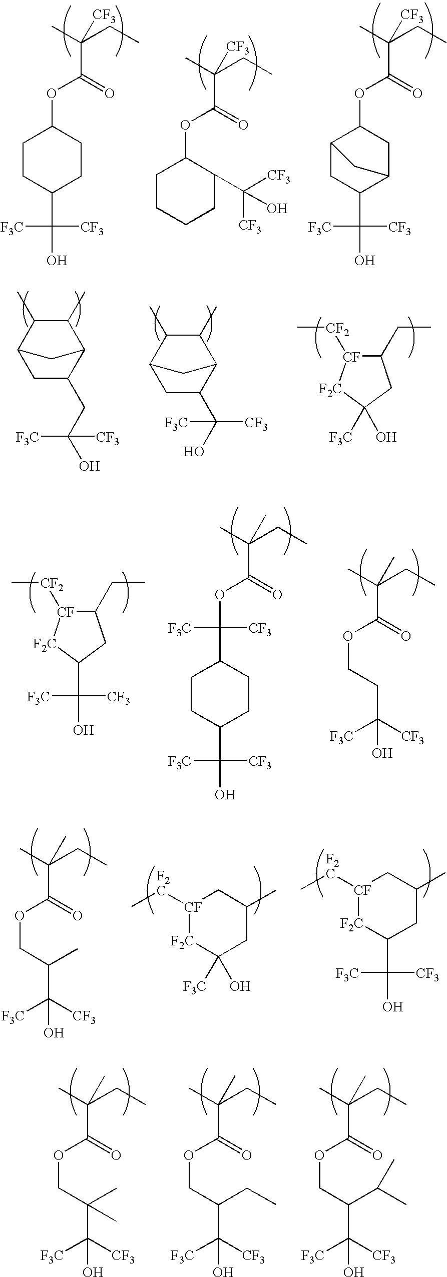

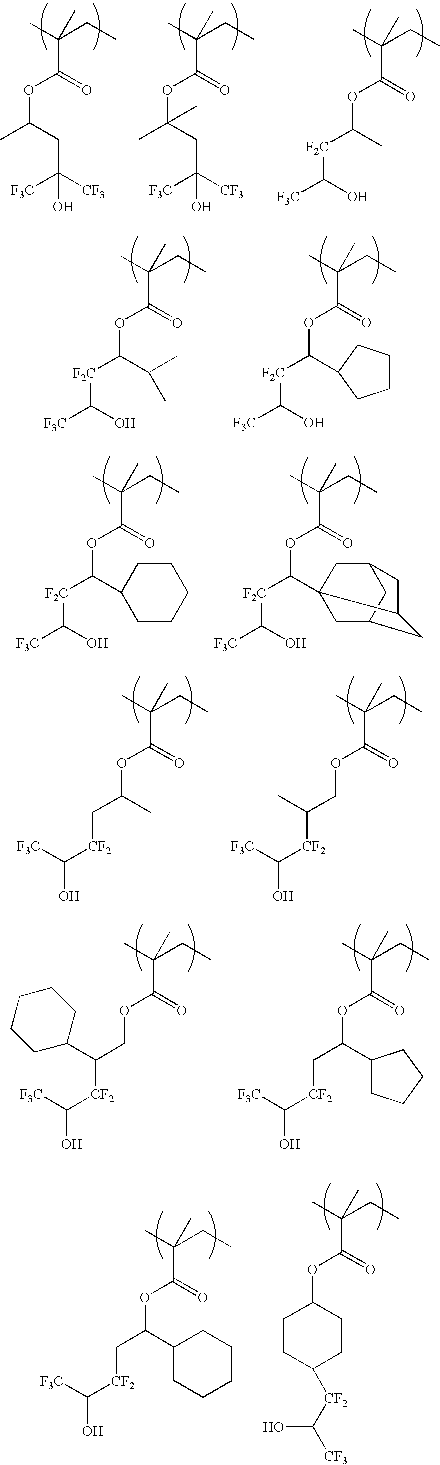

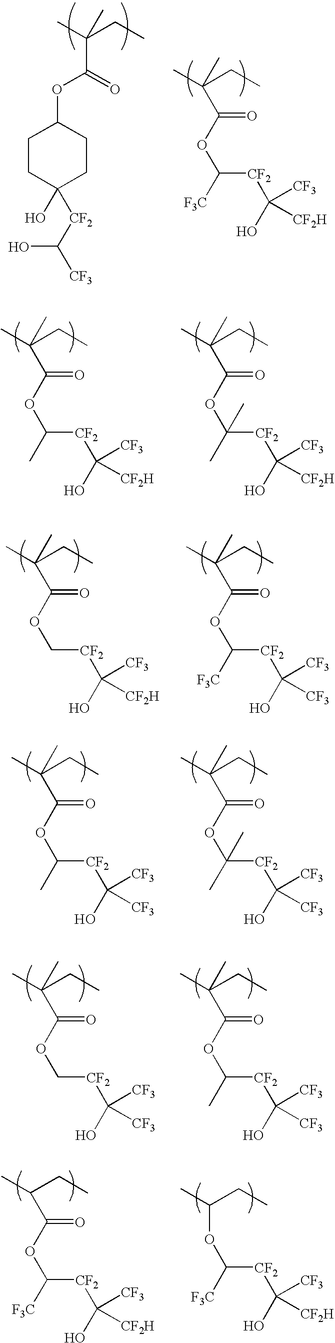

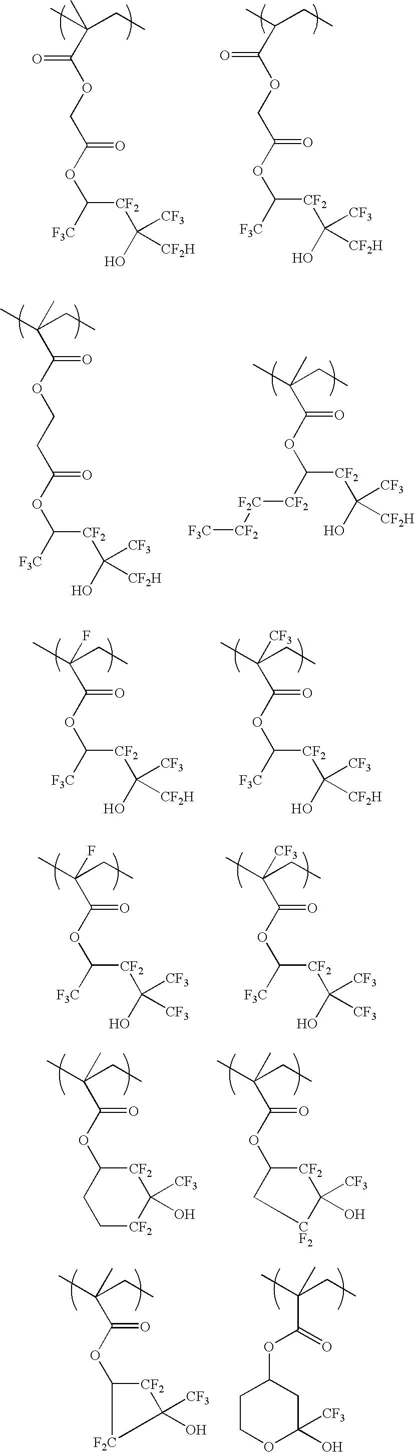

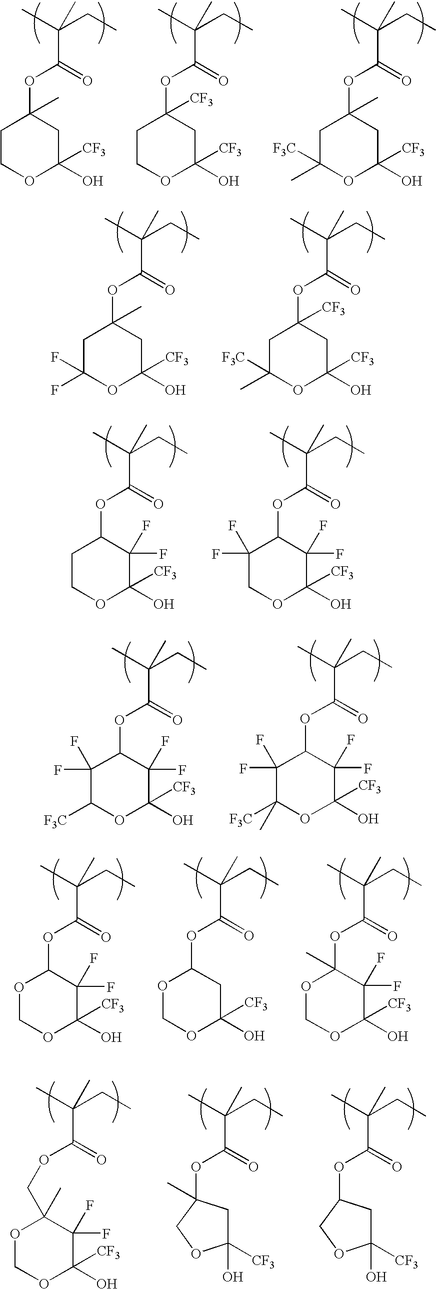

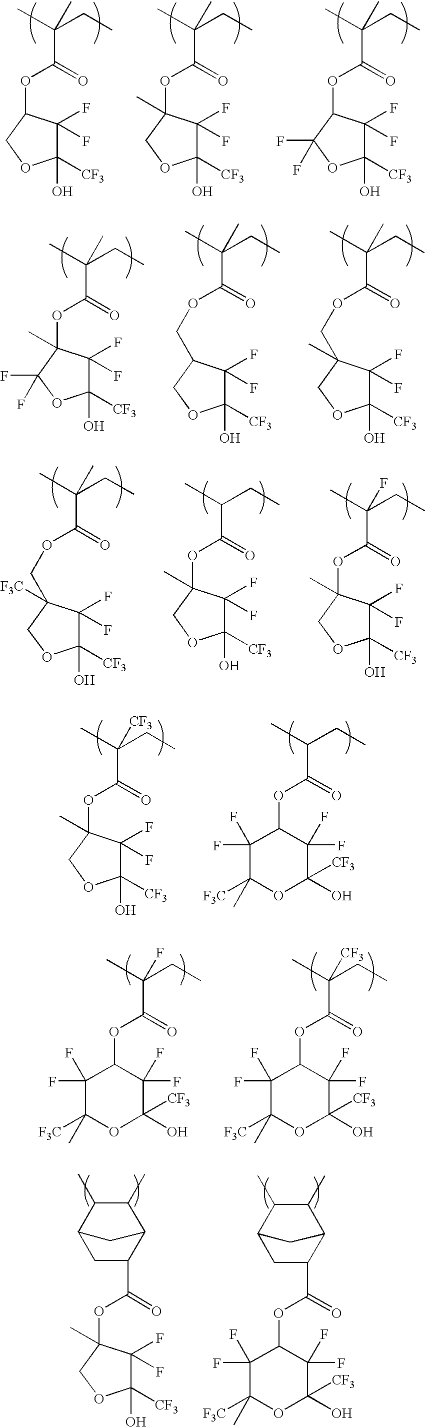

The foregoing polymers must have alkali-soluble groups of formula (1) and may have hydrophobic group-containing recurring units copolymerized and incorporated therein for improving water repellency and water lubricity. Fluoroalkyl and alkyl groups are typical hydrophobic groups while a combination of both is more effective in improving water lubricity.

Examples of recurring units “b” having a fluoroalkyl group are given below.

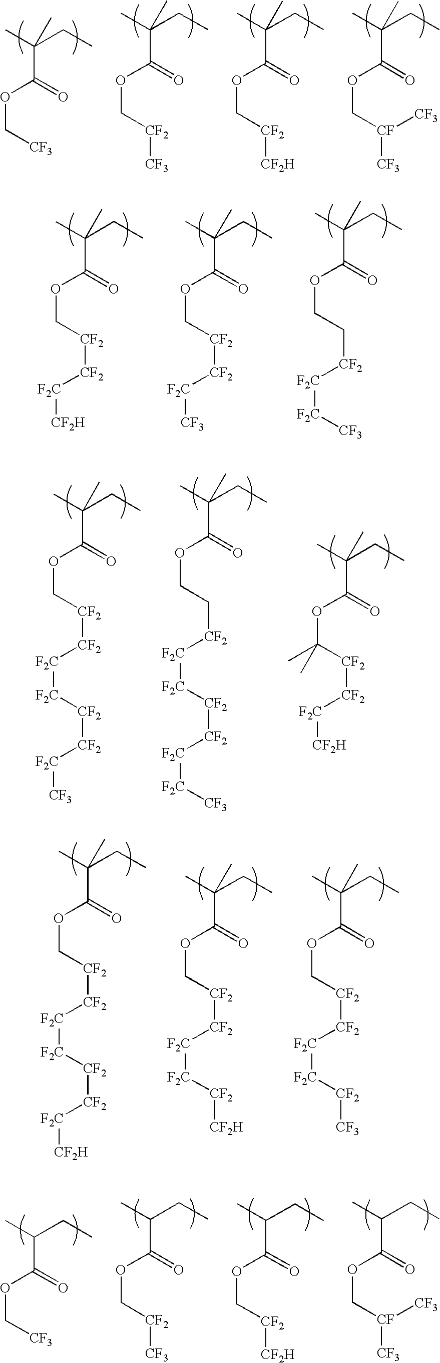

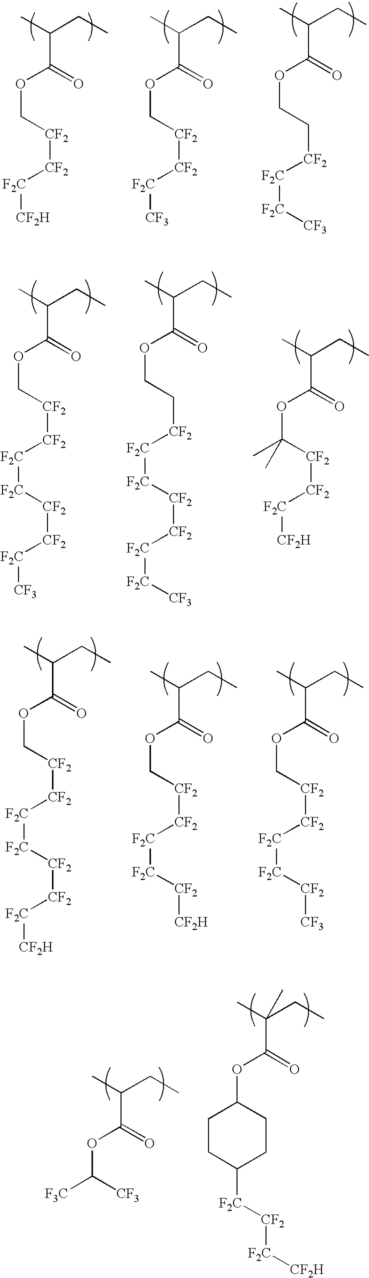

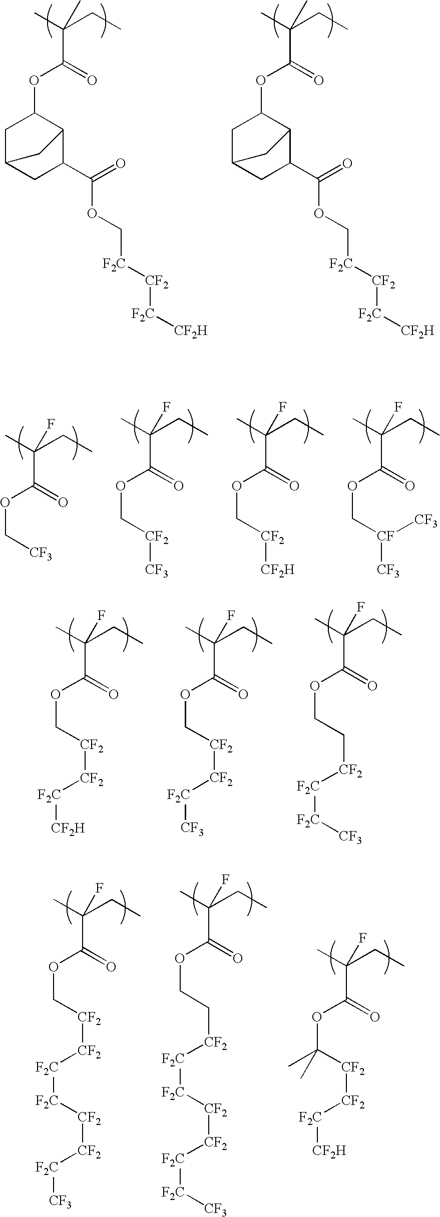

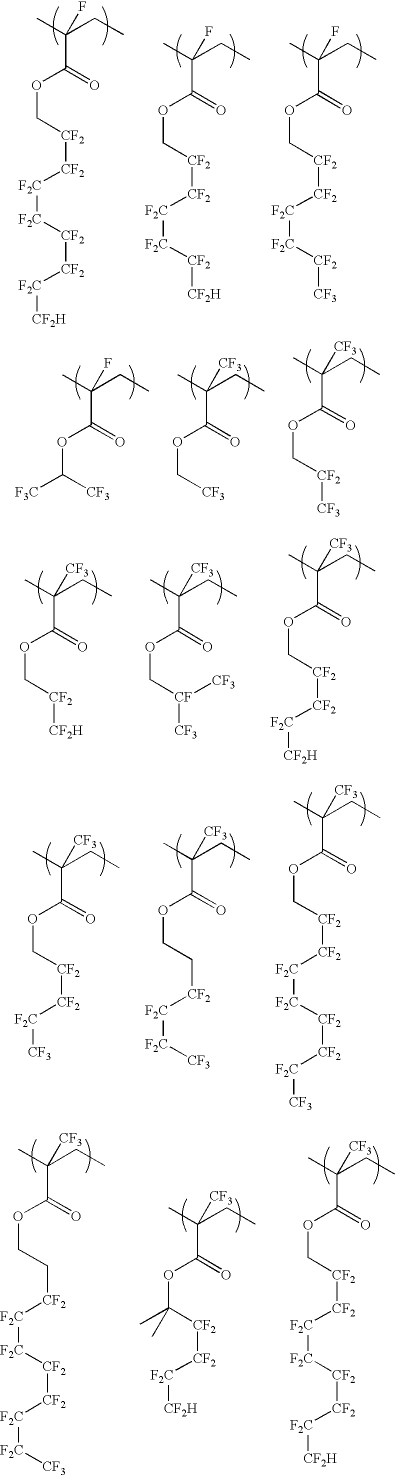

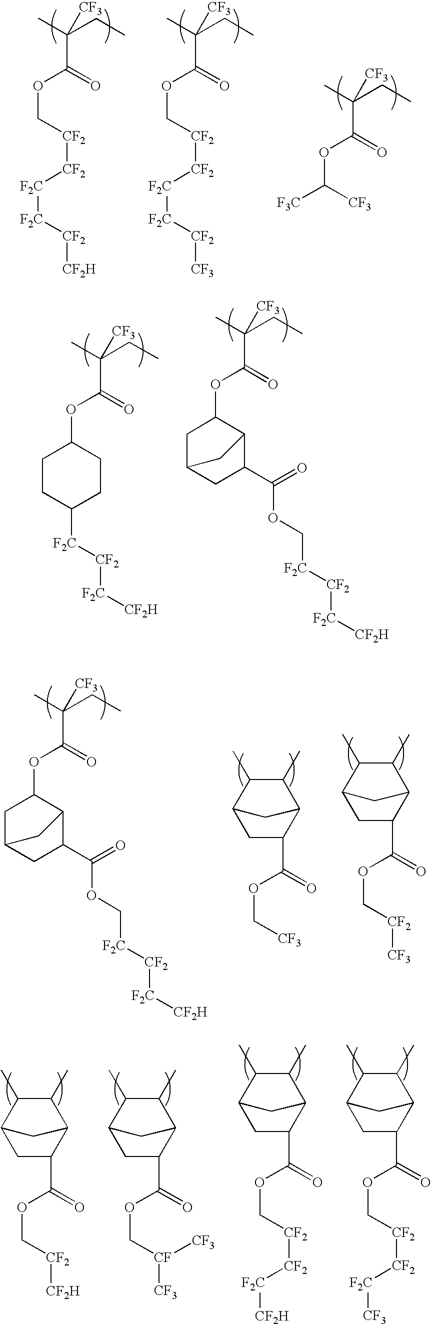

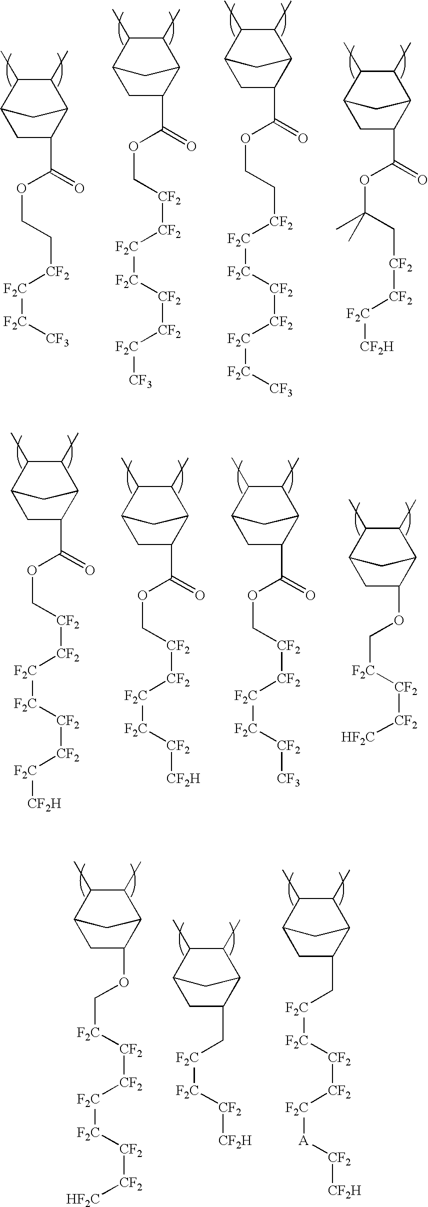

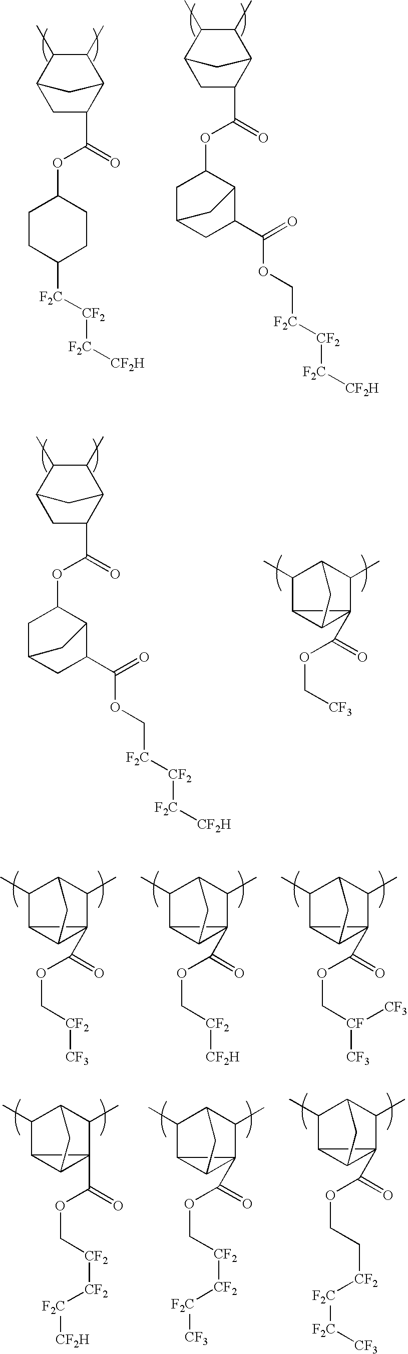

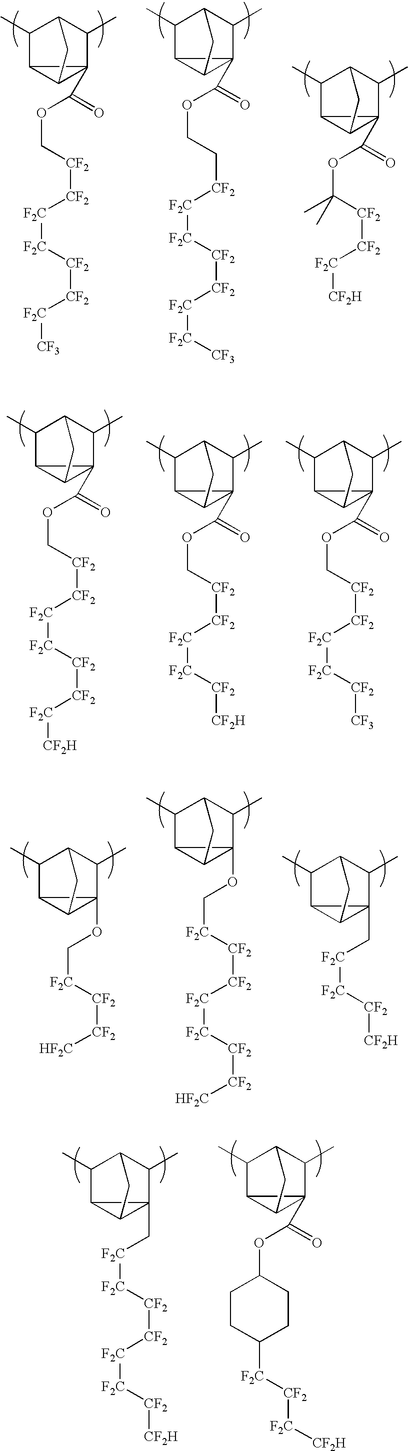

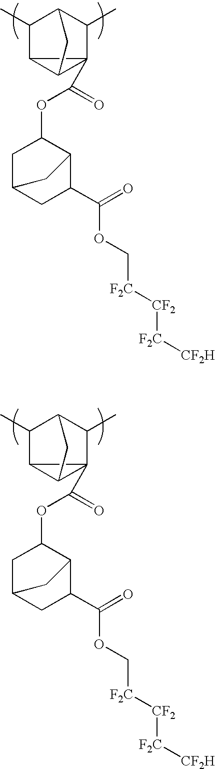

Examples of recurring units “c” having an alkyl group are given below.

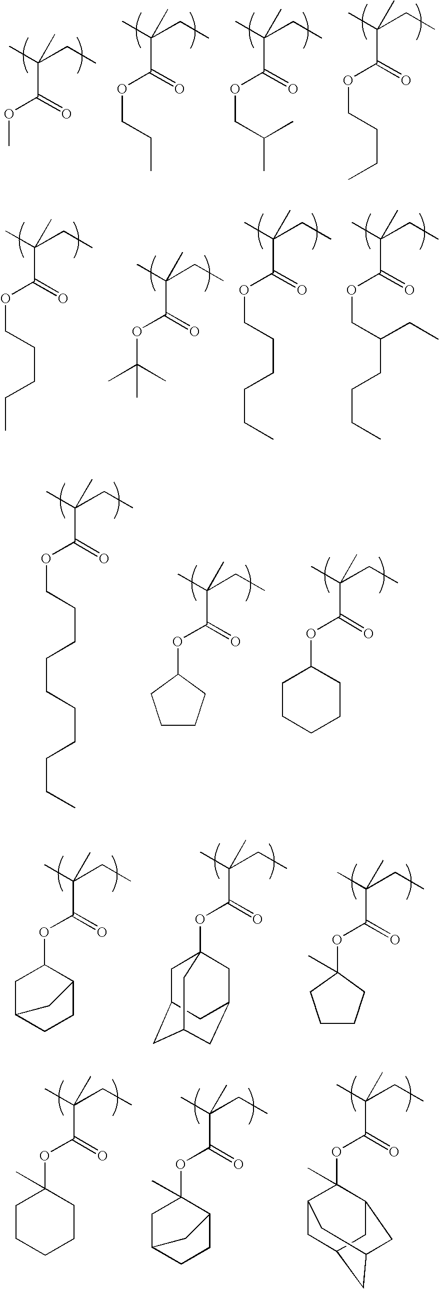

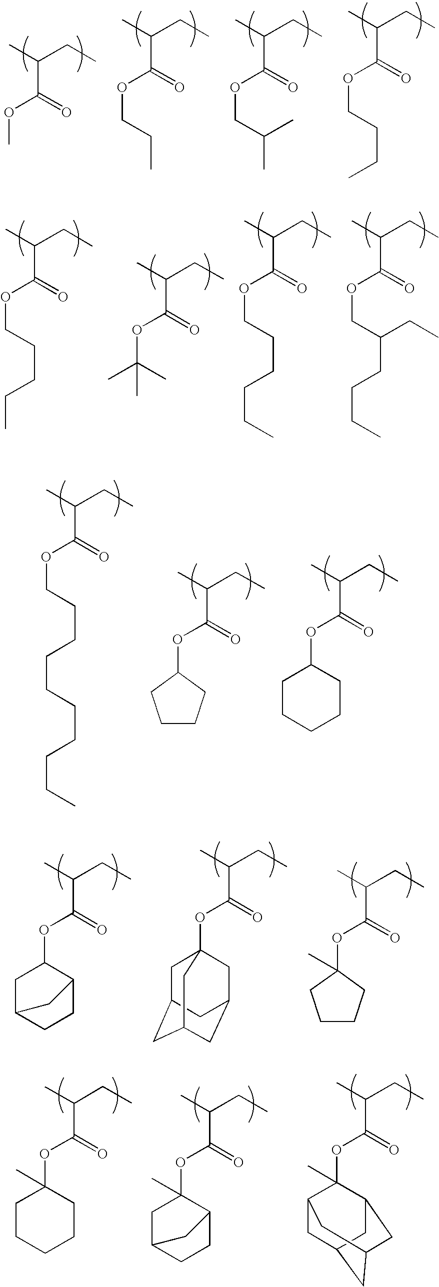

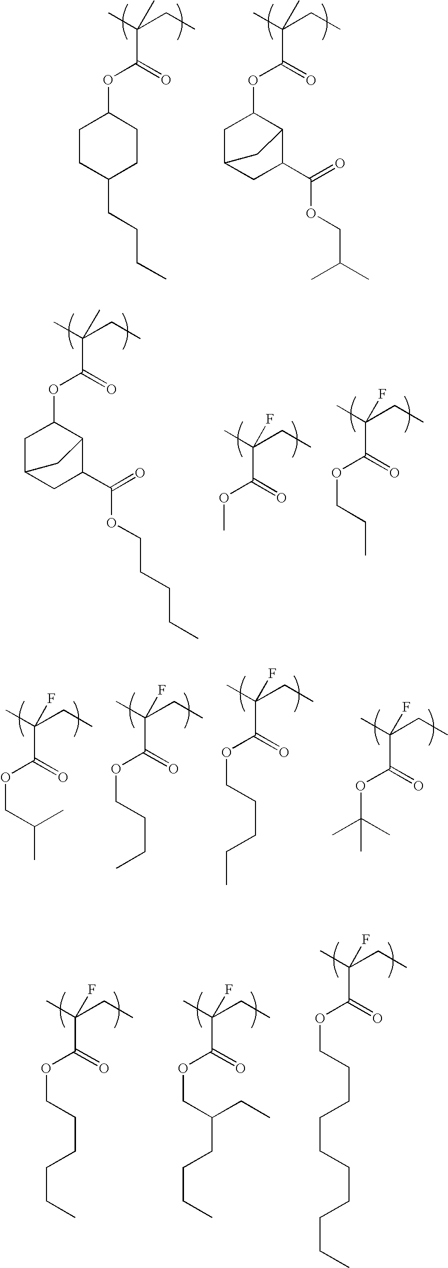

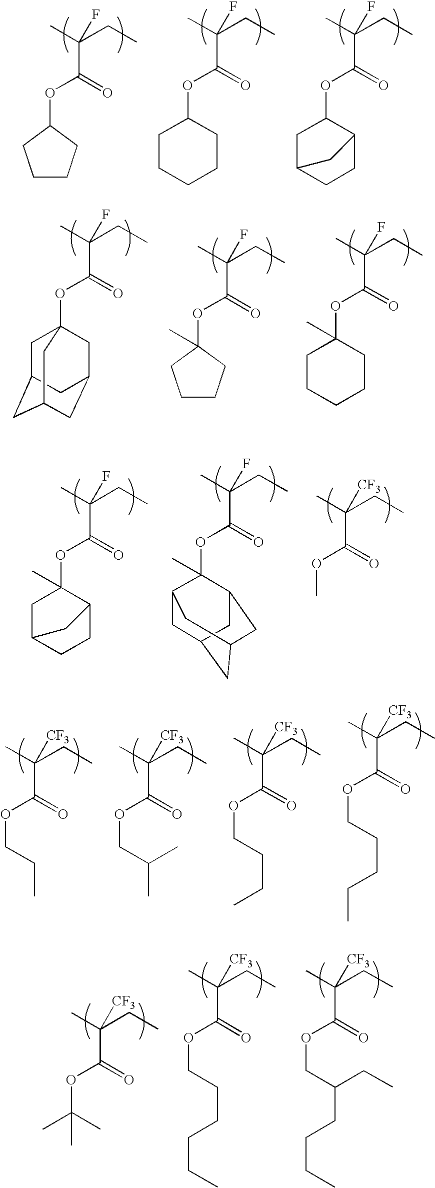

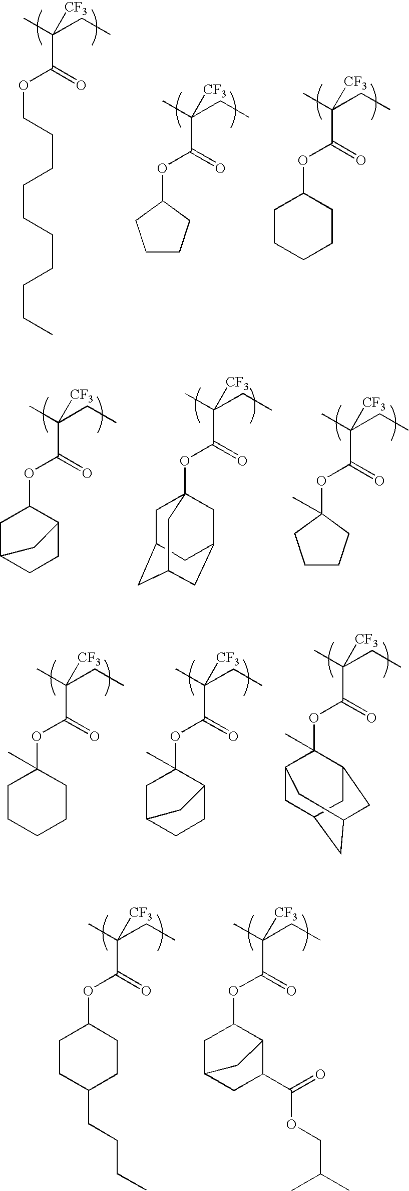

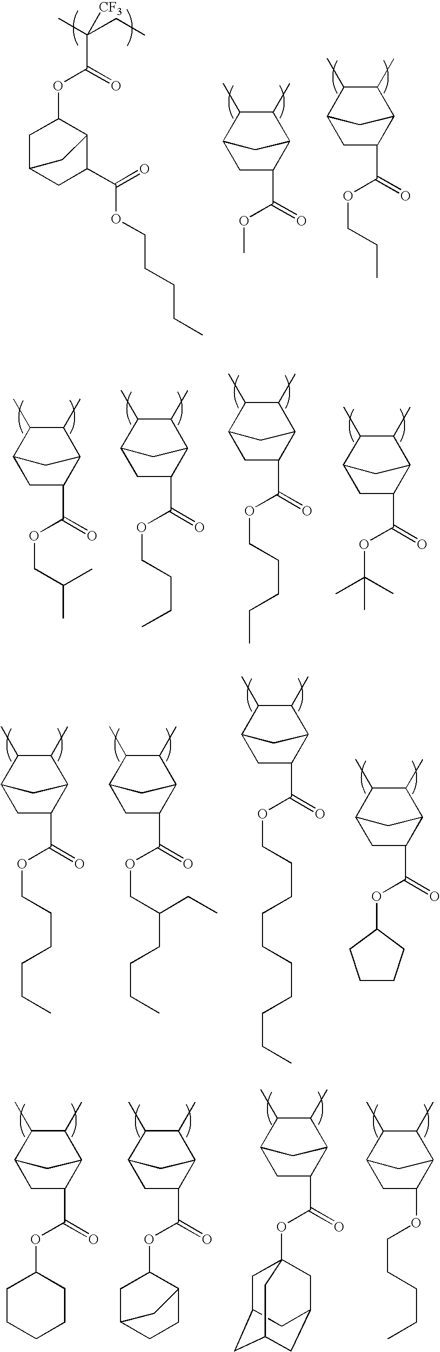

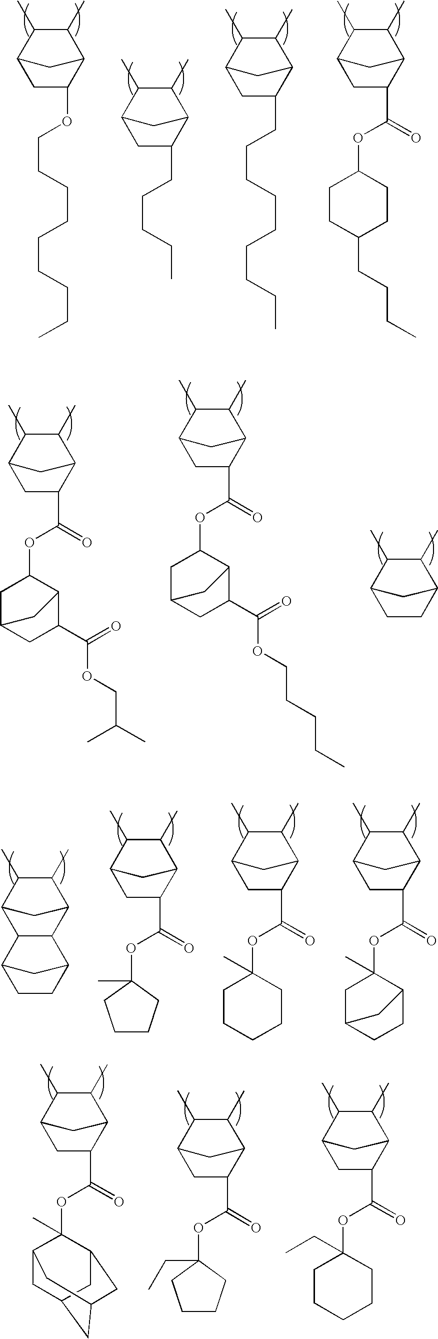

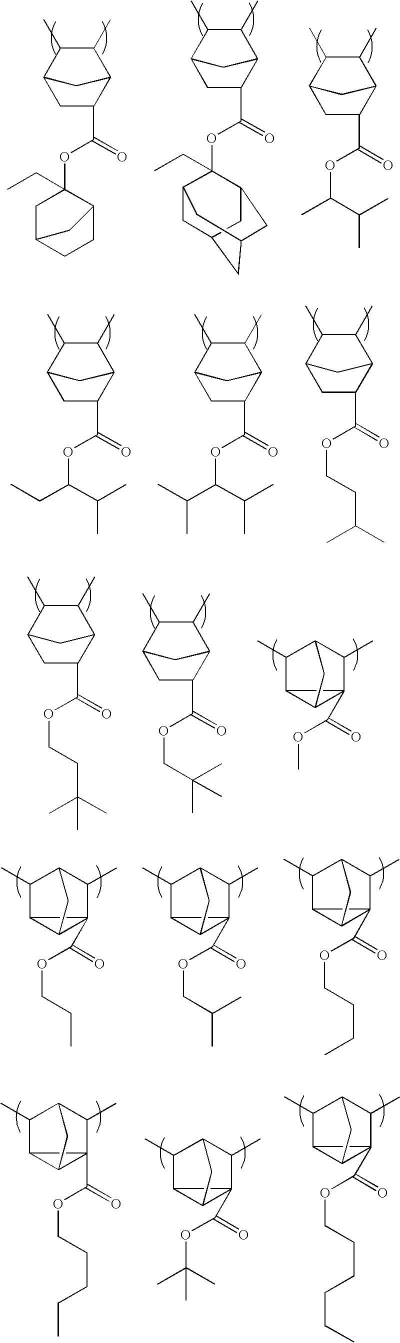

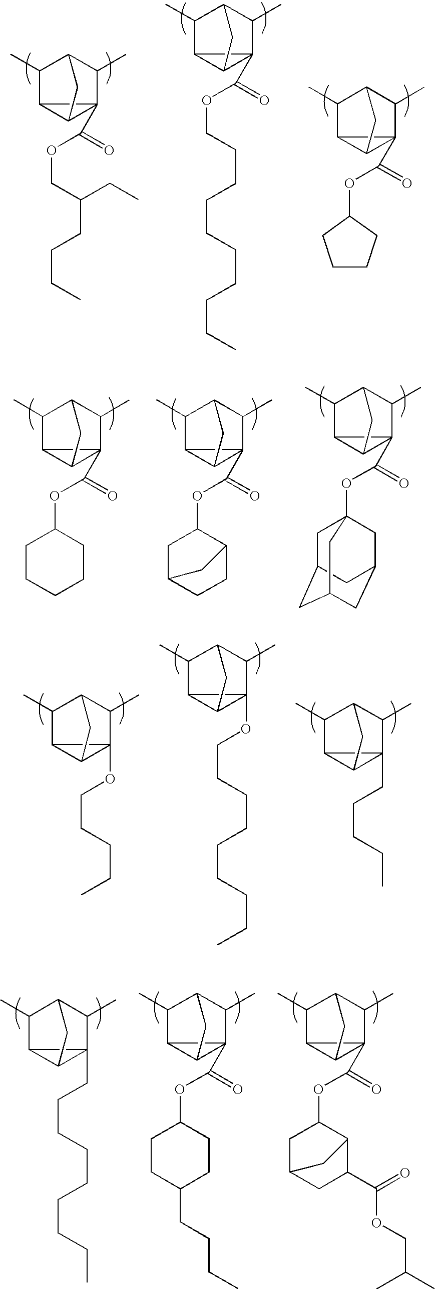

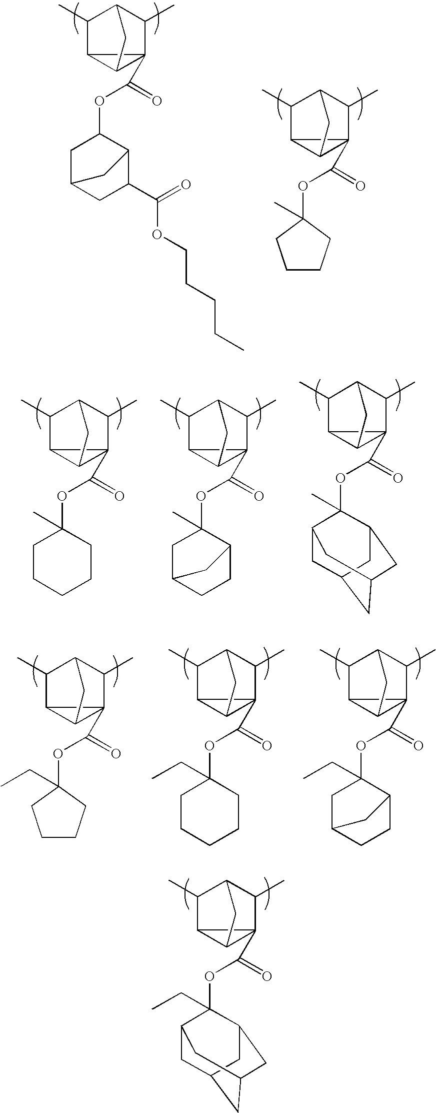

Inclusion of recurring units “a” enables to form a resist protective coating having a dissolution rate of equal to or less than 0.1 angstrom/second (Å/s) in water and a dissolution rate of equal to or more than 300 Å/s in a developer, i.e., 2.38 wt % TMAH aqueous solution. Inclusion of recurring units “b” and “c” is effective for improving water repellency and water lubricity.

In the polymer for the resist protective coating of the invention, recurring units “d” having a carboxyl group may be copolymerized for the purpose of preventing the protective coating from mixing with the resist film. Examples of recurring units “d” are given below.

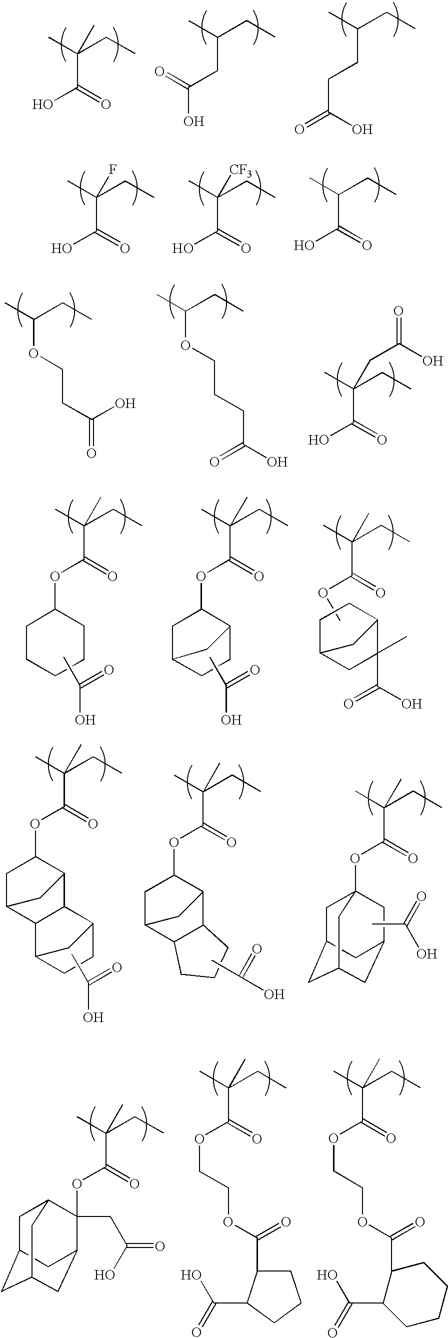

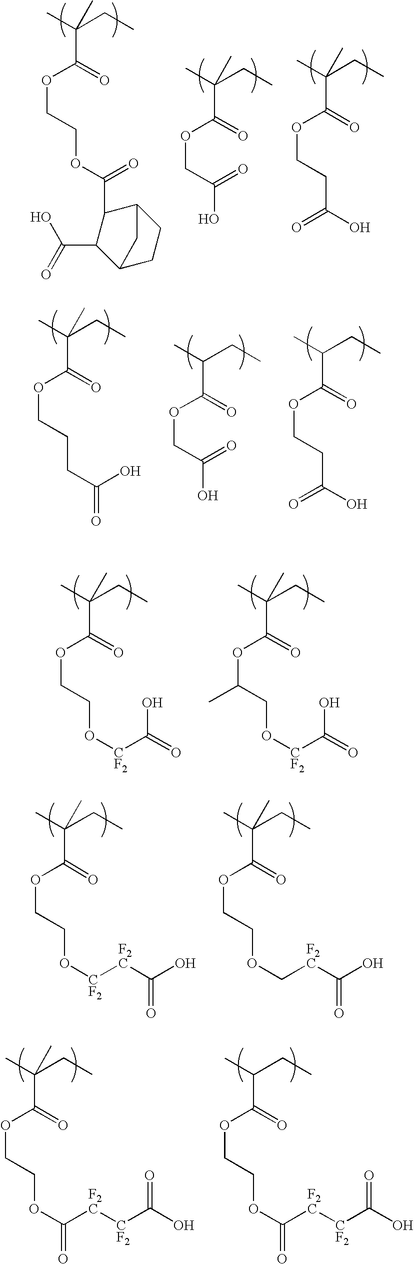

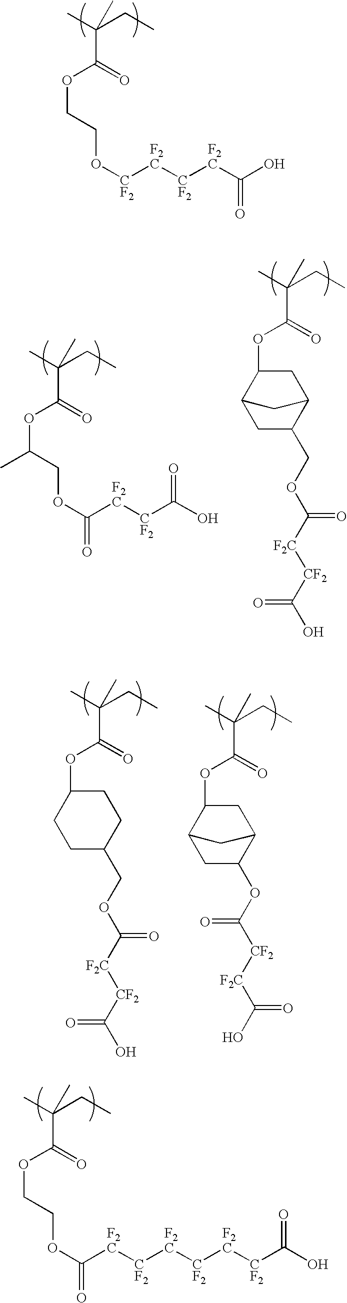

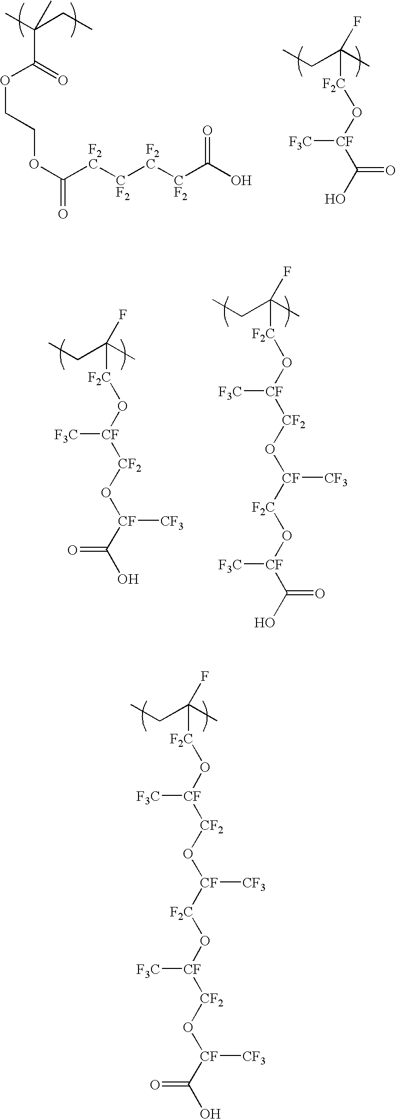

In the polymer, the recurring units a, b, c and d are included in a proportion: 0<a≦1.0, 0≦b≦0.9, 0≦c≦0.9, 0≦d≦0.9, and preferably 0<a≦0.8, 0≦b≦0.8, 0≦c≦0.6, 0≦d≦0.8, provided that a+b+c+d=1. It is meant by a+b+c+d=1 that in a polymer comprising recurring units a, b, c, and d, the total of recurring units a, b, c, and d is 100 mol % of the total of entire recurring units of the polymer.

The polymers used herein should preferably have a weight average molecular weight (Mw) of 1,000 to 500,000, more preferably 2,000 to 30,000, as determined by gel permeation chromatography (GPC) versus polystyrene standards. A polymer with too low a Mw may be mixable with the resist material or dissolvable in water whereas too high a Mw may interfere with film formation after spin coating and lead to a decline of alkali solubility.

The polymers may be synthesized by any desired method, for example, by dissolving unsaturated bond-containing monomers corresponding to the respective recurring units “a” to “d” in an organic solvent, adding a radical initiator thereto, and effecting heat polymerization. Examples of the organic solvent which can be used for polymerization include toluene, benzene,. tetrahydrofuran, diethyl ether, dioxane, methanol, ethanol and isopropanol. Examples of the polymerization initiator used herein include 2,2′-azobisisobutyronitrile (AIBN), 2,2′-azobis(2,4-dimethylvaleronitrile), dimethyl 2,2-azobis(2-methylpropionate), benzoyl peroxide, and lauroyl peroxide. Preferably the system is heated at 50 to 80° C. for polymerization to take place. The reaction time is about 2 to 100 hours, preferably about 5 to 20 hours. It is acceptable that sulfo groups are in the form of alkali metal salts in the monomeric stage and after polymerization, acid treatment is conducted to resume sulfonic acid residues.

In the practice of the invention, the polymer is dissolved in a suitable solvent selected from C₈-C₁₂ ether compounds, especially C₁₀-C₁₂ ether compounds from the point of view of safety that the flash point becomes at least room temperature (25° C.), inter alia, di-n-pentyl ether, diisopentyl ether, di-sec-pentyl ether, di-t-amyl ether, and di-n-hexyl ether, or a solvent mixture of a C₈-C₁₂ ether compound and 0.1 to 90% by weight of a C₄-C₁₀ higher alcohol, fluorochemical solvent and/or alkane solvent to form a solution which is ready for use as the resist protective coating material. For film formation by spin coating technique, the solvent is preferably used in such amounts to provide a polymer concentration of 0.1 to 20% by weight, more preferably 0.5 to 10% by weight.

To the solvent used herein, an antioxidant may be added. The addition of an antioxidant is preferred because the ether solvent can be oxidized to form a peroxide having a risk of explosion. The antioxidant is often selected from phenol compounds as described in JP-A 2004-198812, JP-A 2005-047945, and JP-A 2005-227528.

Since the resist protective coating material is used in the semiconductor manufacturing process, the content of metals, alkali metals and alkaline earth metals should be minimal, specifically equal to or less than 100 ppb, more specifically equal to or less than 10 ppb. To this end, the solvent is preferably subjected to metal-removing treatment such as distillation or ion exchange resins. The metal-removing treatment may be carried out at the solvent purification stage or at the stage of a solution of polymer in solvent. Purification at both the stages is more effective in reducing the metal content.

The lithography pattern forming process of the invention involves the steps of forming a photoresist layer on a wafer, forming a protective coating on the photoresist layer from a resist overlay material, exposing the layer structure to light, and developing. The process is characterized in that the resist overlay material is the water-insoluble, alkali-soluble resist protective coating material defined above.

Specifically, first the water-insoluble, alkali-soluble resist overlay material is applied to a photoresist layer on a wafer by suitable techniques, typically spin coating. The coating thickness is preferably in a range of 10 to 500 nm. The lithography used herein may be either dry lithography wherein a gas such as air or nitrogen is present between the resist protective coating and the projection lens, or immersion lithography wherein a liquid fills in between the resist protective coating and the projection lens. The immersion lithography favors water. In the immersion lithography, whether or not the wafer edge and rear side are cleaned and the cleaning technique are important in preventing flowing of water to the wafer rear side and leaching from the substrate. After spin coating, the resist protective coating is baked at a temperature of 40 to 130° C. for 10 to 300 seconds for evaporating off the solvent. In the case of resist layer formation and dry lithography, edge cleaning is performed during the spin coating. In the case of immersion lithography, contact of water with the substrate surface which is fully hydrophilic is undesirable because water may be left on the substrate surface at the edge. It is then recommended to omit edge cleaning during the spin coating of the resist protective coating.

Once the resist protective coating is formed, light exposure in water is carried out by KrF or ArF immersion lithography. This is followed by post-exposure bake (PEB) and development in an alkaline developer for 10 to 300 seconds. An aqueous solution of 2.38 wt % tetramethylammonium hydroxide (TMAH), which is commonly used as the alkaline developer, is used herein whereby stripping of the resist protective coating and development of the resist layer are simultaneously effected. Sometimes water is left on the resist protective coating prior to PEB. If PEB is performed in the presence of residual water, water can penetrate through the protective coating to suck up the acid in the resist, impeding pattern formation. To fully remove the water on the protective coating prior to PEB, the water on the protective coating should be dried or recovered by suitable means, for example, spin drying prior to PEB, purging of the protective coating surface with dry air or nitrogen, or optimizing the water recovery nozzle configuration or process on a stage after the exposure. Additionally, the resist protective coating of the invention has high water repellency and thus offers the advantage of efficient water recovery.

The type of photoresist material is not particularly limited. The photoresist may be either positive or negative working and also either a monolayer resist of conventional hydrocarbon or a bilayer resist containing silicon atoms and the like. For KrF lithography resist materials, the preferred base resins are polyhydroxystyrene or polyhydroxystyrene-(meth)acrylate copolymers in which hydrogen atoms of hydroxyl or carboxyl groups are replaced by acid labile groups.

For ArF lithography resist materials, the base resin must have an aromatic-free structure. Illustrative polymers include polyacrylic acid and derivatives thereof, norbornene derivative-maleic anhydride alternating copolymers and ternary or quaternary copolymers thereof with polyacrylic acid or derivatives thereof, tetracyclododecene derivative-maleic anhydride alternating copolymers and ternary or quaternary copolymers thereof with polyacrylic acid or derivatives thereof, norbornene derivative-maleimide alternating copolymers and ternary or quaternary copolymers thereof with polyacrylic acid or derivatives thereof, tetracyclododecene derivative-maleimide alternating copolymers and ternary or quaternary copolymers thereof with polyacrylic acid or derivatives thereof, and polynorbornene and metathesis ring-opening polymers, and a combination of any.

### EXAMPLE

Examples of the invention are given below by way of illustration and not by way of limitation. All parts are by weight. The weight average molecular weight (Mw) and number average molecular weight (Mn) are determined by gel permeation chromatography (GPC) versus polystyrene standards, and the molecular weight dispersity (Mw/Mn) is computed therefrom. Examples 1-23 and Comparative Examples 1-7

Resist protective coating polymers, designated PCP 1 to 12, were prepared by radical polymerization. The structure of these polymers is shown below together with Mw and Mw/Mn.

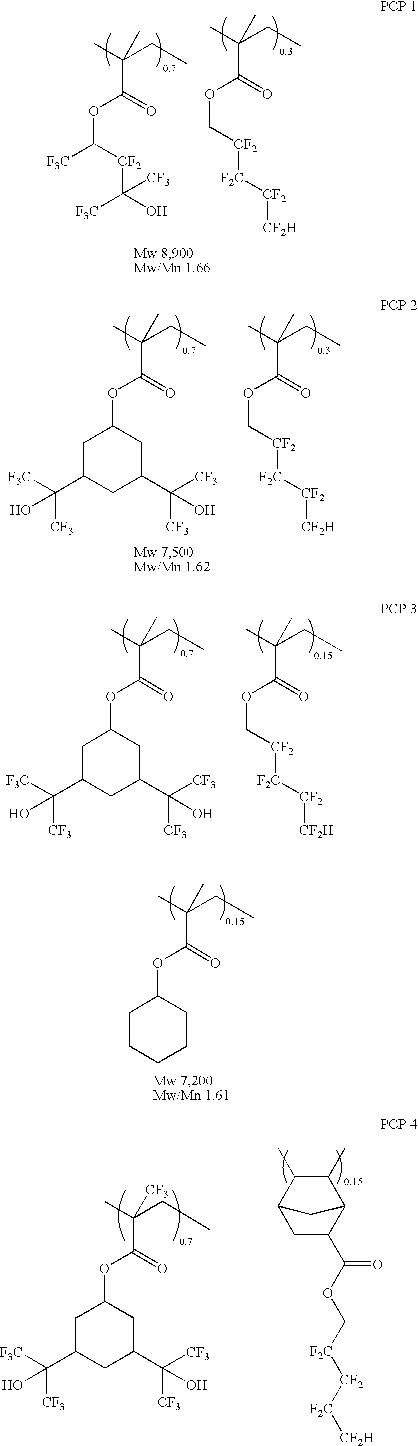

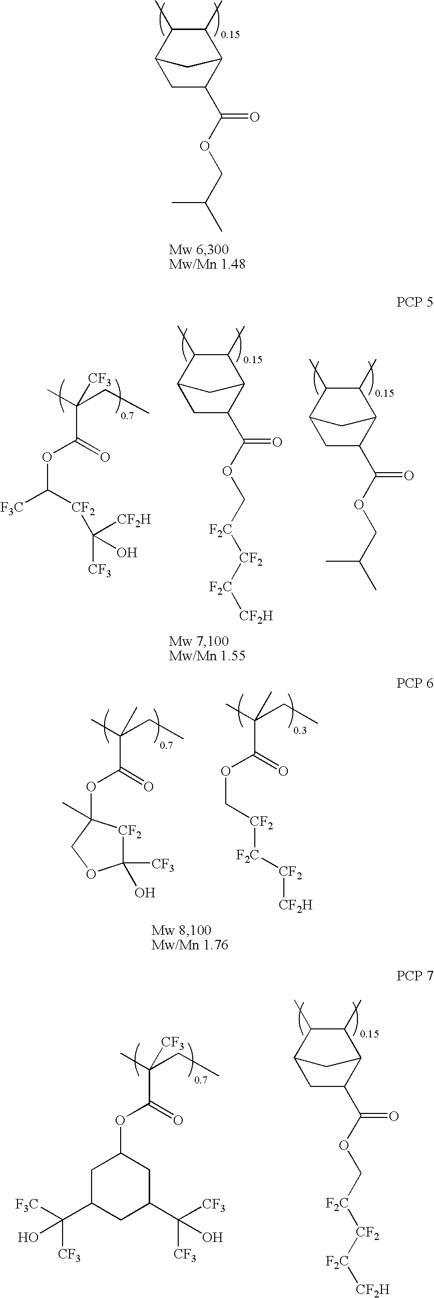

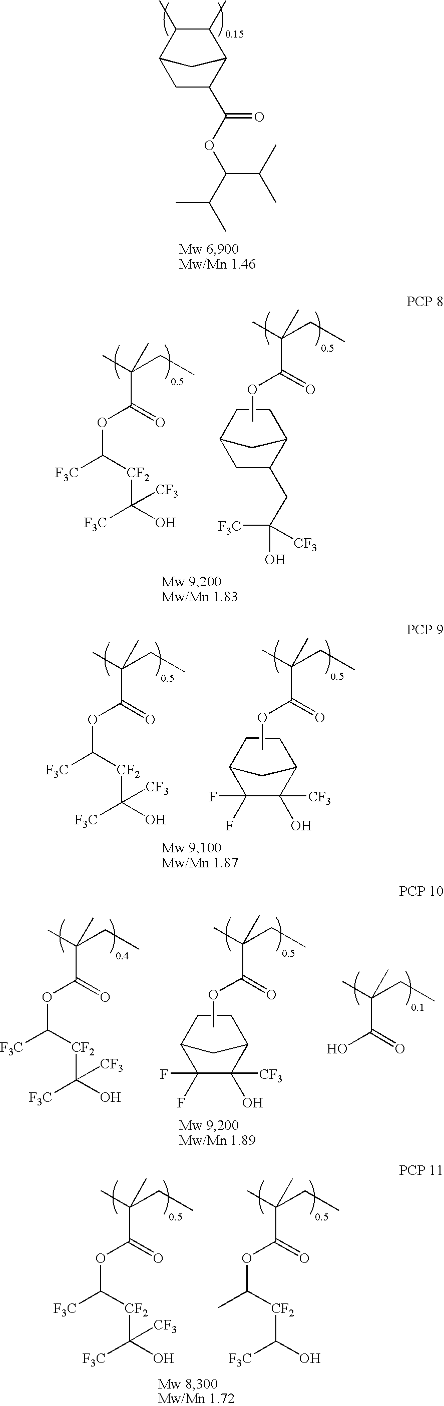

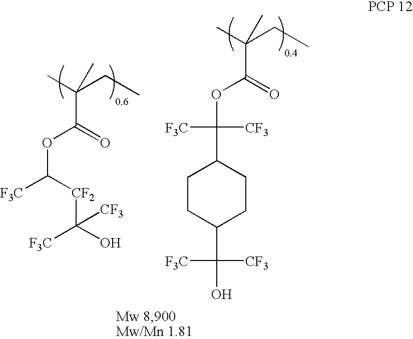

Resist protective coating solutions were prepared by combining 3.5 parts of protective coating polymers PCP1 to 12 with 100 parts of a solvent according to the formulation shown in Table 1, and filtering through a high-density polyethylene (HDPE) filter having a pore size of 0.1 micron.

A resist solution was prepared by dissolving 100 parts of a resist polymer, designated RP1 to 4 and shown below, 6 parts of an acid generator (PAG) and 0.8 part of a quencher in 1,300 parts of propylene glycol monomethyl ether acetate (PGMEA), and filtering through a HDPE filter having a pore size of 0.1 micron.

An antireflective coating ARC-29A (Nissan Chemical Co., Ltd.) was formed on a silicon substrate to a thickness of 80 nm. The resist solution was applied onto the antireflective coating and baked at 110° C. for 60 seconds, forming a resist film of 200 nm thick. The resist protective coating solution was applied onto the resist film and baked at 110° C. for 60 seconds. In order to simulate immersion lithography, light exposure was followed by rinsing of the coating with deionized water for 5 minutes. The structure was exposed by means of an ArF scanner model S307E (Nikon Corp., NA 0.85, σ 0.93, 6% halftone phase shift mask), rinsed for 5 minutes while splashing deionized water, post-exposure baked (PEB) at 110° C. for 60 seconds, and developed with a 2.38 wt % TMAH aqueous solution for 60 seconds.

The wafers were sectioned for comparing the profile of a hole pattern including holes of 120 nm in diameter at a pitch of 240 nm. The results are shown in Table 1.

In the absence of the protective coating, a conventional process including light exposure, PEB and development, but excluding water rinsing after exposure was also carried out. The results are shown in Table 2.

TABLE 1

| | | Protective | | |
|---|---|---|---|---|
| | Solvent | coating | Resist | Pattern |
| | (weight ratio) | polymer | polymer | profile |
| Example 1 | di-n-butyl ether | PCP1 | RP4 | rectangular |
| Example 2 | diisopentyl ether | PCP1 | RP4 | rectangular |
| Example 3 | di-sec-pentyl ether | PCP1 | RP4 | rectangular |
| Example 4 | di-t-amyl ether | PCP1 | RP4 | rectangular |
| Example 5 | diisopentyl ether:isobutyl alcohol (9:1) | PCP1 | RP3 | rectangular |
| Example 6 | diisopentyl ether:3-methyl-1-butanol (9:1) | PCP1 | RP3 | rectangular |
| Example 7 | diisopentyl ether:2-methyl-1-butanol (9:1) | PCP1 | RP3 | rectangular |
| Example 8 | diisopentyl ether:2-pentanol (9:1) | PCP1 | RP3 | rectangular |
| Example 9 | diisopentyl ether:1-hexanol (9:1) | PCP1 | RP3 | rectangular |
| Example 10 | diisopentyl ether:2-methyl-1-butanol (9:1) | PCP1 | RP1 | rectangular |
| Example 11 | diisopentyl ether:2-methyl-1-butanol (9:1) | PCP1 | RP2 | rectangular |
| Example 12 | diisopentyl ether:2-methyl-1-butanol (9:1) | PCP2 | RP3 | rectangular |
| Example 13 | diisopentyl ether:2-methyl-1-butanol (9:1) | PCP3 | RP3 | rectangular |
| Example 14 | diisopentyl ether:2-methyl-1-butanol (9:1) | PCP4 | RP3 | rectangular |
| Example 15 | diisopentyl ether:2-methyl-1-butanol (9:1) | PCP5 | RP3 | rectangular |
| Example 16 | diisopentyl ether:n-decane (9:1) | PCP1 | RP3 | rectangular |
| Example 17 | diisopentyl ether:2,2,2-trifluoroethyl butyrate (8:2) | PCP1 | RP3 | rectangular |
| Example 18 | diisopentyl ether:4-methyl-2-pentanol (7:3) | PCP1 | RP3 | rectangular |
| Example 19 | diisopentyl ether:3-methyl-3-pentanol (7:3) | PCP1 | RP3 | rectangular |
| Example 20 | diisopentyl ether:1-hexanol (9:1) | PCP1 | RP3 | rectangular |
| Example 21 | diisopentyl ether:tert-amyl alcohol (7:3) | PCP1 | RP3 | rectangular |
| Example 22 | diisopentyl ether:1-pentanol (9:1) | PCP1 | RP3 | rectangular |
| Example 23 | diisopentyl ether:2-methyl-1-butanol (9:1) | PCP6 | RP3 | rectangular |
| Example 24 | diisopentyl ether:2-methyl-1-butanol (9:1) | PCP7 | RP3 | rectangular |
| Example 25 | diisopentyl ether:2-methyl-1-butanol (9:1) | PCP8 | RP3 | rectangular |
| Example 26 | diisopentyl ether:2-methyl-1-butanol (9:1) | PCP9 | RP3 | rectangular |
| Example 27 | diisopentyl ether:2-methyl-1-butanol (9:1) | PCP10 | RP3 | rectangular |
| Example 28 | diisopentyl ether:2-methyl-1-butanol (9:1) | PCP11 | RP3 | rectangular |
| Example 29 | diisopentyl ether:2-methyl-1-butanol (9:1) | PCP12 | RP3 | rectangular |
| Comparative | isobutyl alcohol | PCP1 | RP2 | top bridge |
| Example 1 | | | | |
| Comparative | isobutyl alcohol | PCP1 | RP3 | top bridge |
| Example 2 | | | | |
| Comparative | isobutyl alcohol | PCP1 | RP4 | resist |
| Example 3 | | | | dissolved away |
| Comparative | 2-methyl-1-butanol | PCP1 | RP3 | top bridge |
| Example 4 | | | | |

TABLE 2

| | Resist polymer | Pattern profile |
|---|---|---|
| Comparative Example 5 | RP2 | rectangular |
| Comparative Example 6 | RP3 | rectangular |
| Comparative Example 7 | RP4 | rectangular |

The structure, Mw and Mw/Mn of the resist polymers are shown below as well as the photoacid generator and quencher.

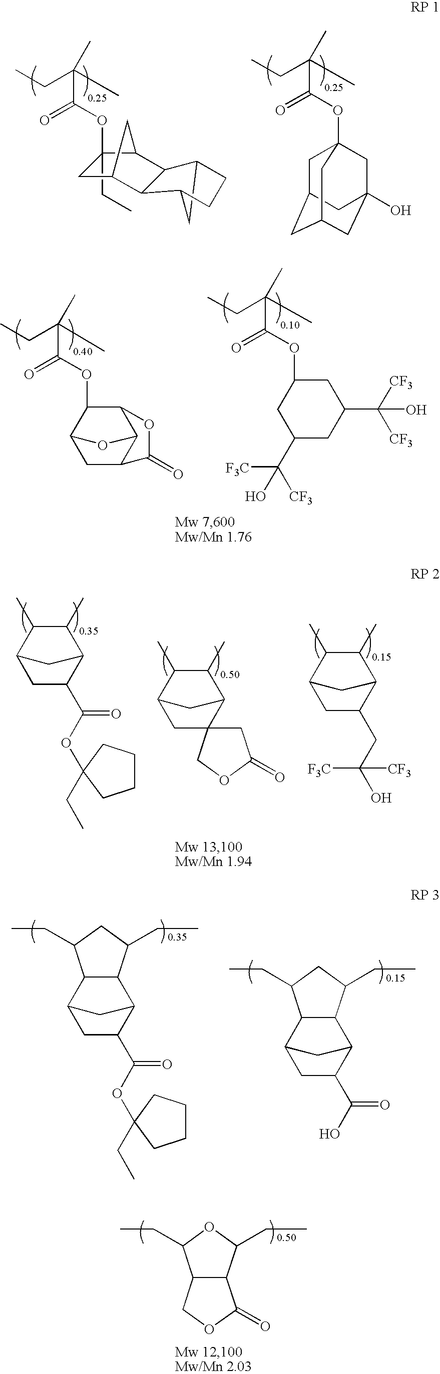

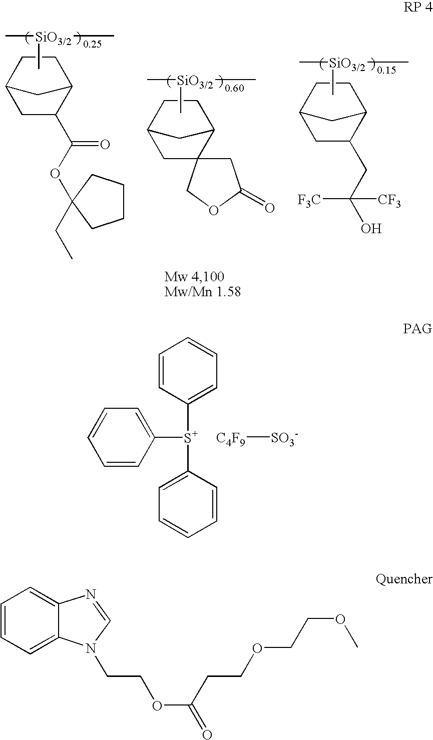

Separately, a pre-spinning experiment was carried out for examining whether a resist protective coating material was effectively applied after a C₈-C₂ ether compound was previously spin coated.

Sources of the protective coating material in Example 2 and an ether compound were line connected to Clean Track ACT-8 (Tokyo Electron, Ltd.). A resist solution having resist polymer RP1 added was spin coated onto a 8-inch wafer and prebaked at 120° C. for 60 seconds to form a resist film of 150 nm thick. An ether compound was dispensed on the resist film while rotating the wafer at 1,000 rpm. By rotating at 1,500 rpm for 20 seconds, any extra ether compound was spun off the resist film. Then the protective coating material in Example 2 was dispensed on the wet resist film in a coating amount of 1 mL while rotating the wafer at 500 rpm. This was followed by spin coating at 1,500 rpm for 20 seconds and prebaking at 110° C. for 60 seconds to form a resist protective coating of 50 nm thick. Using a spectroscopic film thickness measurement system Lambda-Ace VM-3010 (Dainippon Screen Mfg. Co., Ltd.), the thickness of the resist protective coating was measured at 21 points in a diametrical direction of the 8″ wafer, determining a film thickness distribution (difference between maximum and minimum).

The results are shown in Table 3.

TABLE 3

| | Pre-spinning | 8″ wafer in-plane variation |
|---|---|---|
| Spin coating run | solvent | (nm) |
| Run 1 | di-n-butyl ether | 0.3 |
| Run 2 | diisopentyl ether | 0.4 |
| Run 3 | di-n-hexyl ether | 0.3 |
| Run 4* | nil | 1.5 |
| Run 5* | isobutyl alcohol | 2.5 |

*Reference example

### Examples 30-45 & Comparative Examples 8-10

Resist protective coating solutions were prepared by combining 3.5 parts of protective coating polymer PCP1 with 100 parts of a solvent according to the formulation shown in Table 4, and filtering through a HDPE filter having a pore size of 0.1 micron.

A resist solution was prepared by dissolving 100 parts of resist polymer RP1, 6 parts of an acid generator (PAG) and 0.8 part of a quencher in 1,300 parts of PGMEA, and filtering through a HDPE filter having a pore size of 0.1 micron.

An antireflective coating ARC-29A (Nissan Chemical Co., Ltd.) was formed on a silicon substrate to a thickness of 80 nm. The resist solution was applied onto the antireflective coating and baked at 110° C. for 60 seconds, forming a resist film of 200 nm thick. The resist protective coating solution was applied onto the resist film and baked at 110° C. for 60 seconds to form a protective coating of 50 nm thick. Using an ArF scanner model S307E (Nikon Corp., NA 0.85, σ 0.93), open-frame exposure over the entire wafer surface was performed in an exposure dose of 50 mJ/cm².

20 mL of deionized water was dispensed on the wafer as exposed and kept there for 5 minutes, after which the water was recovered. The amount of nonafluorobutanesulfonic acid (from PAG) dissolved in the water was determined by a liquid chromatograph 1100-Series LS/MSD 1100SL by Agilent Technologies.

In comparative runs, exposure was performed in the absence of the protective coating. The amount of nonafluorobutanesulfonic acid was similarly determined.

It is noted that this liquid chromatograph had a determination limit of 0.1 ppb of nonafluorobutanesulfonic acid.

The results are shown in Table 4.

TABLE 4

| | | Protective | | Acid |
|---|---|---|---|---|
| | Solvent | coating | Resist | dissolved |
| | (weight ratio) | polymer | polymer | (ppb) |
| Example 30 | di-n-butyl ether | PCP1 | RP1 | ≦0.1 |
| Example 31 | diisopentyl ether | PCP1 | RP1 | ≦0.1 |
| Example 32 | di-sec-pentyl ether | PCP1 | RP1 | ≦0.1 |
| Example 33 | di-t-amyl ether | PCP1 | RP1 | ≦0.1 |
| Example 34 | diisopentyl ether:isobutyl alcohol (9:1) | PCP1 | RP1 | ≦0.1 |
| Example 35 | diisopentyl ether:3-methyl-1-butanol (9:1) | PCP1 | RP1 | ≦0.1 |
| Example 36 | diisopentyl ether:2-methyl-1-butanol (9:1) | PCP1 | RP1 | ≦0.1 |
| Example 37 | di-n-pentyl ether:2-pentanol (9:1) | PCP1 | RP1 | ≦0.1 |
| Example 38 | diisopentyl ether:1-hexanol (9:1) | PCP1 | RP1 | ≦0.1 |
| Example 39 | diisopentyl ether:n-decane (9:1) | PCP1 | RP1 | ≦0.1 |
| Example 40 | diisopentyl ether:2,2,2-trifluoroethyl butyrate (8:2) | PCP1 | RP1 | ≦0.1 |
| Example 41 | diisopentyl ether:4-methyl-2-pentanol (7:3) | PCP1 | RP1 | ≦0.1 |
| Example 42 | diisopentyl ether:3-methyl-3-pentanol (7:3) | PCP1 | RP1 | ≦0.1 |
| Example 43 | diisopentyl ether:1-hexanol (9:1) | PCP1 | RP1 | ≦0.1 |
| Example 44 | diisopentyl ether:tert-amyl alcohol (7:3) | PCP1 | RP1 | ≦0.1 |
| Example 45 | diisopentyl ether:1-pentanol (9:1) | PCP1 | RP1 | ≦0.1 |
| Comparative | isobutyl alcohol | PCP1 | RP1 | 2.0 |
| Example 8 | | | | |
| Comparative | 2-methyl-1-butanol | PCP1 | RP1 | 3.8 |
| Example 9 | | | | |
| Comparative | — | nil | RP1 | 65 |
| Example 10 | | | | |

As seen from the data in Tables 1 to 4, when resist protective coatings were applied using C₈-C₂ ether compounds as the solvent, neither resist dissolution nor intermixing occurred with any resist materials including resist materials based on (meth)acrylate polymers, polynorbornene, ROMP polymers, and silsesquioxane polymers. In addition, rectangular resist patterns could be formed as in the absence of the protective coating. The use of the solvent within the scope of the invention was effective in minimizing the amount of acid dissolved out of the resist.

Japanese Patent Application Nos. 2005-343101 and 2006-120106 are incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A resist protective coating material comprising an ether compound of 8 to 12 carbon atoms as a solvent.

2. The resist protective coating material of claim 1, wherein the ether compound is selected from the group consisting of di-n-butyl ether, diisobutyl ether, di-sec-butyl ether, di-n-pentyl ether, diisopentyl ether, di-sec-pentyl ether, di-t-amyl ether, and di-n-hexyl ether, and mixtures thereof.

3. The resist protective coating material of claim 1, wherein the ether compound is diisopentyl ether.

4. The resist protective coating material of claim 1, further comprising a higher alcohol of 4 to 10 carbon atoms in admixture with the ether compound in an amount of 0.1 to 90% by weight based on the ether compound and the alcohol combined.

5. The resist protective coating material of claim 1, further comprising a fluorochemical solvent.

6. The resist protective coating material of claim 1, further comprising an alkali-soluble polymer having alpha-trifluoromethyl alcohol groups.

7. The resist protective coating material of claim 6, wherein the alkali-soluble polymer comprises recurring units having an alpha-trifluoromethyl alcohol group, and recurring units having a fluoroalkyl group and/or recurring units having an alkyl group.

8. The resist protective coating material of claim 7, wherein the alkali-soluble polymer further comprises recurring units having a carboxyl group.

9. A lithography process for forming a pattern, comprising the steps of forming a photoresist layer on a wafer, forming a protective coating on the photoresist layer from a resist overlay material, exposing the layer structure to light, and developing,
said resist overlay material being the resist protective coating material of claim 1.

10. An immersion lithography process for forming a pattern, comprising the steps of forming a photoresist layer on a wafer, forming a protective coating on the photoresist layer from a resist overlay material, exposing the layer structure in water to light, and developing,
said resist overlay material being the resist protective coating material of claim 1.

11. The process of claim 10, wherein the exposing step includes irradiating light having a wavelength in the range of 180 to 250 nm to the layer structure through a projection lens while keeping water between the projection lens and the wafer.

12. The process of claim 6, wherein the developing step is to develop the photoresist layer and strip the protective coating of resist overlay material at the same time, using a liquid alkaline developer.

13. An immersion lithography process for forming a pattern, comprising the steps of forming a photoresist layer on a wafer, wetting the photoresist layer with a solution containing an ether compound of 8 to 12 carbon atoms, forming a protective coating on the photoresist layer from a resist overlay material by spin coating, exposing the layer structure in water to light, and developing,
said resist overlay material being the resist protective coating material of claim 1.
